(19) United States
(12) Patent Application Publication
(10) Pub. No.: US 2008/0272246 A1
(43) Pub. Date: Nov. 6, 2008

(54) METHODS AND SYSTEMS FOR ACTIVE NOISE CANCELLATION

(76) Inventors: Samuel Robert Mollet, Grain Valley, MO (US); Michael Scott Mitchell, Lee's Summit, MO (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 11/743,202

(22) Filed: May 2, 2007

(51) Int. Cl. B61L 3/00; H04B 15/00

(52) U.S. Cl. 246/194; 702/189

(57) ABSTRACT

Methods and systems for a cab signal system are provided. The system includes at least one inductive pickup coil assembly, and a cab signal receiver electrically coupled to the at least one inductive pickup coil assembly. The receiver is configured to receive amplitude and phase information associated with an electromagnetic noise signal portion and receive amplitude and phase information associated with a cab signal portion received by the at least one inductive pickup coil assembly. The receiver is further configured to determine a phase difference between electromagnetic noise signal portion and the cab signal portion and combine the electromagnetic noise signal portion and the cab signal portion based on the phase difference such that an amplitude of the electromagnetic noise signal portion is facilitated being reduced.

### BACKGROUND OF THE INVENTION

This invention relates generally to methods and systems for detecting coded or modulated electrical currents that are transmitted through the rails of a railroad track for control purposes and, more particularly, to cab signal systems and methods active noise cancellation of interference signals in cab signal systems.

Railroads establish the speed limit in certain sections of track by the use of cab signals. These signals are comprised of for example, low-frequency (40-4550 Hz) carriers that are keyed off and on at various low data rates. The carriers are transmitted as currents through the rails, which are detected by magnetic pickup coils mounted on the underside of the locomotive. A cab signal receiver installed in the locomotive demodulates the cab signal and measures the on-off keying rate. The measured rate represents the speed limit for that particular section of track. When the cab signal receiver detects that the locomotive has exceeded the speed limit an alarm is sounded, prompting the locomotive engineer to take appropriate action. In some installations, the cab signal receiver halts the train if the engineer fails to respond within a certain period of time.

Modern locomotives use AC traction motors built into the axles of the locomotive drive wheels. Varying the frequency of the applied AC drive voltage controls the speed of the motor. Since the motors are located in close proximity to the cab signal receiver pickup coils, the variable AC signal may interfere with the received cab signal resulting in the possibility of an incorrect detection. Such interference may permit the interference to cause the cab signal receiver to indicate a erroneous speed limit then that established by the signal transmitted in the rails. At least some known cab signal coil assemblies are positioned in a predetermined orientation with respect to the AC traction motor to reduce a magnitude of the interference. However, a phase of the interference may be different than the phase of the received cab signal received by the cab signal coil assemblies resulting in degraded performance of the system.

### BRIEF DESCRIPTION OF THE INVENTION

In one embodiment, a cab signal system includes at least one inductive pickup coil assembly, and a cab signal receiver electrically coupled to the at least one inductive pickup coil assembly wherein the receiver is configured to receive amplitude and phase information associated with an electromagnetic noise signal portion and receive amplitude and phase information associated with a cab signal portion received by the at least one inductive pickup coil assembly. The receiver is further configured to determine a phase difference between the electromagnetic noise signal portion and the cab signal portion, and combine the electromagnetic noise signal portion and the cab signal portion based on the phase difference such that an amplitude of the electromagnetic noise signal portion is facilitated being reduced.

In another embodiment, a method of receiving a railway cab signal on board a railway vehicle includes receiving a control information signal that includes a cab signal component transmitted through railroad rails to a signal coil assembly mounted on board the railway vehicle and an interference component transmitted to the signal coil assembly from an interference source and receiving an interference signal including a magnitude and phase, the interference signal based on interference from a railway vehicle source. The method also includes combining the received control information signal and the interference signal using a phase shift determined from a comparison of the received control information signal and the interference signal such that a 180 degree phase shift is maintained between the received control information signal and the interference signal.

In still another embodiment, a cab signal system includes at least one inductive pickup coil assembly and a cab signal receiver electrically coupled to the at least one inductive pickup coil assembly. The receiver is configured to receive amplitude and phase information associated with an electromagnetic noise signal portion, and receive amplitude and phase information associated with a cab signal portion received by the at least one inductive pickup coil assembly. The cab signal system also includes a phase shifter configured to determine a phase difference between electromagnetic noise signal portion and the cab signal portion and combine the electromagnetic noise signal portion and the cab signal portion based on the phase difference such that an amplitude of the electromagnetic noise signal portion is facilitated being reduced.

### BRIEF DESCRIPTION OF THE DRAWINGS

FIG. 1 is a schematic block diagram of a cab signal pickup coil assembly in accordance with an exemplary embodiment of the present invention; and

FIG. 2 is a schematic block diagram of a cab signal system in accordance with an exemplary embodiment of the present invention.

### DETAILED DESCRIPTION OF THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

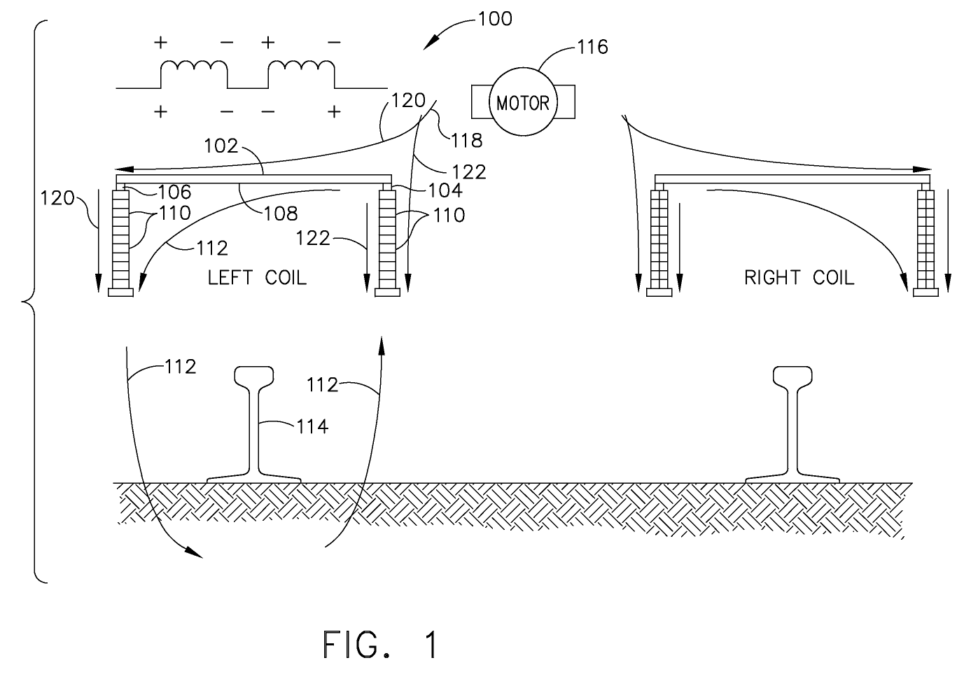

FIG. 1 is a schematic block diagram of a cab signal pickup coil assembly 100 in accordance with an exemplary embodiment of the present invention. In the exemplary embodiment, cab signal pickup coil assembly 100 includes a U-shaped core 102 that includes a first leg pickup coil assembly 104, a second leg pickup coil assembly 106, and a connecting bar 108 extending therebetween. One or more pickup coils 110 are concentrically arranged about each pickup coil assembly 104 and 106. An alternating magnetic field 112 circulates about a rail 114 proximate cab signal pickup coil assembly 100. Magnetic field 112 is channeled through U-shaped core 102 and magnetically interacts with pickup coils 110 to generate an output relative to the strength and frequency of magnetic field 112.

In the exemplary embodiment, an electric motor 116 is positioned proximate cab signal pickup coil assembly 100 such that a magnetic field 118 emanating from electric motor 116 may be received by cab signal pickup coil assembly 100 as a signal interfering with the receiving of the cab signal from rail 114. A first portion 120 of magnetic field 118 is channeled through leg pickup coil assembly 106 and a second portion of magnetic field 118 is channeled through leg pickup coil assembly 104. During one-half of a cycle of the alternating magnetic field 112 from the cab signal traveling though rail 114, first portion 120 is additive to magnetic field 112 (boost) and second portion 122 is subtractive from magnetic field 112 (buck). Pickup coils 110 of each leg pickup coil assembly 104 and 106 are each interconnected in series and the resulting coil assemblies are also electrically coupled in series. Because the interfering magnetic field 118 is additive to the cab signal in leg pickup coil assembly 106 and subtractive in leg pickup coil assembly 104, the output signal from cab signal pickup coil assembly 100 due to interfering magnetic field 118 is facilitated being reduced. However, because of the difference in position between various pickup coils 110 and the different distances from rail 114 and motor 116, the phase of first portion 120 and second portion 122 are different such that the respective signals are not canceled.

In the exemplary embodiment, coils 110 are sensitive to both cab signal and noise wherein the noise is out of phase with the cab signal in at least one of first leg pickup coil assembly 104 and second leg pickup coil assembly 106. The cab signal and noise may be substantially in-phase in the other coil. In such case an output of first leg pickup coil assembly 104 and second leg pickup coil assembly 106 are sensed, and combined either in the analog domain or the digital domain where phase is a variable between the two sensed coils and set to minimize the noise in the absence of cab signal.

The output in the time domain is described by:

Out(t)=A*In1(t)+B*In2(t+/−C) where, (1)

In1(t) represents a first input in the time domain,

In2(t) represents a second input in the time domain, and

A, B, and C are coefficients tuned to minimize Out(t) in the absence of the cab signal.

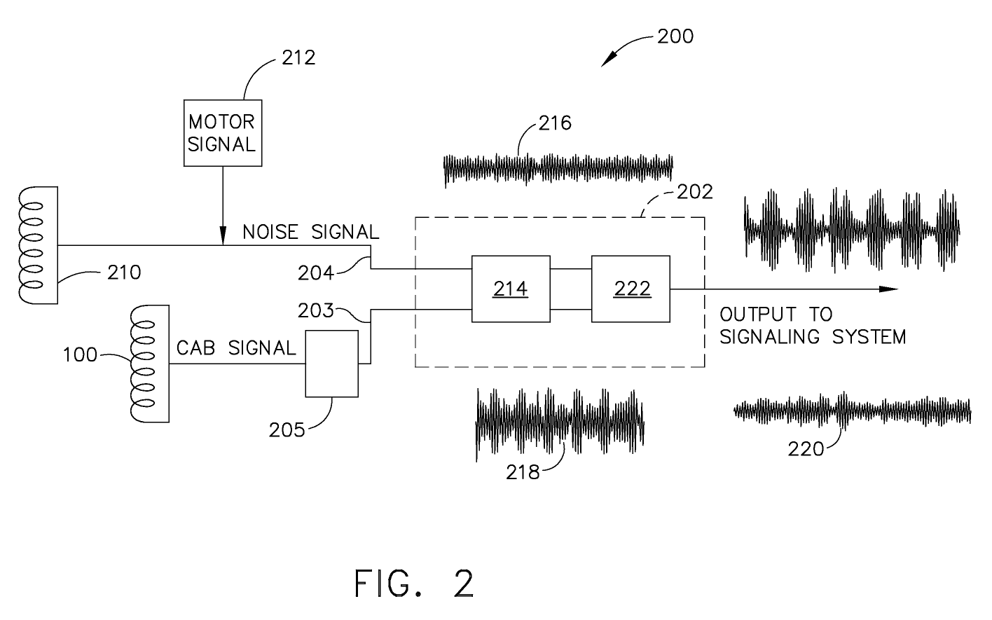

FIG. 2 is a schematic block diagram of a cab signal system 200 in accordance with an exemplary embodiment of the present invention. In the exemplary embodiment, cab signal system 200 includes an inductive track receiver such as pickup coil assembly 100 communicatively coupled to a cab signal system receiver 202 through a data acquisition sub system 205 to an input 203. Data acquisition sub system 205 is configured to receive output signals from a plurality of pick up coils 110, which may provide an output individually of in groups of more than one pick up coil 110. Receiving inputs from a plurality of pickup coils facilitates phase detection and phase shifting of signals to improve noise cancellation. Cab signal system 200 also includes an input 204 representative of noise generated by a traction motor operating proximate pickup coil assembly 100 such that the noise interferes with the cab signal received from a railway rail. Motor operating parameters may be sensed by a motor signal module 212 communicatively coupled to motor 116, a motor controller (not shown), and/or other sensors to determine an operating mode of motor 116. For example, in the exemplary embodiment, a motor speed signal, a motor voltage signal, a motor current signal, and/or a motor torque signal may be used to relate a phase and/or amplitude of the noise from motor 116 to the noise signal input into receiver 202. In addition, an operating mode of motor 116 may be input to motor signal module 212. Such operating modes may include, but are not limited to the propulsion mode of motor 116 such as a propulsion mode, a retarding mode, and a pulse width modulation mode.

Receiver 202 includes a phase shifter 214 configured to receive noise signal input 204 and cab signal input 203. Phase shifter 214 is configured to maintain a 180-degree phase shift for proper noise cancellation. Noise signal input 204 includes only a noise relating to the operation of motor 116. A trace 216 illustrates an exemplary noise signal. Cab signal input 203 includes a cab signal component received from rail 114 (shown in FIG. 1) and an interference component received through an interaction of interfering magnetic field 118 with core 102. A trace 218 illustrates an exemplary cab signal that includes interfering noise. Phase shifter 214 determines a phase difference between noise signal input 204 and cab signal input 203 and shifts the phase a determined amount to ensure noise signal input 204 and the interference component of cab signal input 203 are facilitated. A trace 220 illustrates an exemplary signal from phase shifter 214. In an embodiment, the noise profile may be acquired from a noise sensing coil 210 positioned proximate pickup coil assembly 100 to sense the noise emanating from motor 116. Noise sensing coil 210 is positioned such that it is substantially insensitive to the cab signal from rail 202.

A processing module 222 receives the phase shifted cab signal from phase shifter 214. Processing module 222 is configured to combine the phase-shifted signals. A trace 224 illustrates an exemplary processed cab signal output from system 200.

The above-described methods and systems for providing active noise cancellation in cab signal systems. The methods and systems described herein provide a real-time phase shifted noise cancellation system that is cost-effective and highly reliable.

While the invention has been described in terms of various specific embodiments, those skilled in the art will recognize that the invention can be practiced with modification within the spirit and scope of the claims.

What is claimed is:

1. A cab signal system comprising:
at least one inductive pickup coil assembly; and
a cab signal receiver electrically coupled to said at least one inductive pickup coil assembly, said receiver configured to:
receive amplitude and phase information associated with an electromagnetic noise signal portion;
receive amplitude and phase information associated with a cab signal portion received by said at least one inductive pickup coil assembly;
determine a phase difference between electromagnetic noise signal portion and the cab signal portion; and
combine the electromagnetic noise signal portion and the cab signal portion based on the phase difference such that an amplitude of the electromagnetic noise signal portion is facilitated being reduced.

2. A system in accordance with claim 1 wherein said receiver is further configured to receive amplitude and phase information associated with an electromagnetic noise signal portion received by said at least one inductive pickup coil assembly.

3. A system in accordance with claim 1 wherein said receiver is further configured to determine an amplitude and a phase difference between the electromagnetic noise signal portion and the cab signal portion based on characteristics of at least one electromagnetic noise source and the at least one inductive pickup coil assembly.

4. A system in accordance with claim 3 wherein the characteristics are electromagnetic characteristics.

5. A system in accordance with claim 1 wherein said receiver is further configured to receive at least one of a motor load signal and a propulsion mode signal.

6. A system in accordance with claim 1 wherein the motor load signal comprises at least one of a motor speed signal, a motor voltage signal, a motor current signal, and a motor torque signal.

7. A system in accordance with claim 1 wherein the propulsion mode signal comprises at least one of a propulsion signal, a retarding signal, and a pulse width modulation signal.

8. A system in accordance with claim 1 wherein said receiver is further configured to receive amplitude and phase information associated with an electromagnetic noise signal portion based on at least one of the propulsion mode and the load of a traction motor positioned proximate said at least one inductive pickup coil assembly.

9. A system in accordance with claim 1 wherein said receiver is further configured to shift the phase of the received electromagnetic noise signal portion in real time based on at least one of the propulsion mode and the load of a traction motor positioned proximate said at least one inductive pickup coil assembly such that a noise component of the cab signal portion is facilitated being reduced.

10. A method of receiving a railway cab signal on board a railway vehicle comprises:
receiving a control information signal, the control information signal including a cab signal component transmitted through railroad rails to a signal coil assembly mounted on board the railway vehicle and an interference component transmitted to the signal coil assembly from an interference source;
receiving an interference signal including a magnitude and phase, the interference signal based on interference from a railway vehicle source; and
combining the received control information signal and the interference signal using a phase shift determined from a comparison of the received control information signal and the interference signal such that an approximate 180 degree phase shift is maintained between the received control information signal and the interference signal.

11. A method in accordance with claim 10 wherein receiving an interference signal comprises receiving the interference signal through the signal coil assembly.

12. A method in accordance with claim 10 wherein receiving an interference signal comprises receiving the interference signal from a coil separate from signal coil assembly.

13. A method in accordance with claim 10 wherein receiving an interference signal comprises receiving the interference signal determined based on characteristics of at least one electromagnetic noise source and the at least one inductive pickup coil assembly.

14. A method in accordance with claim 10 wherein combining the received control information signal and the interference signal comprises subtracting the interference component from the control information signal.

15. A method in accordance with claim 10 further comprising receiving at least one of a motor load signal and a propulsion mode signal.

16. A method in accordance with claim 10 further comprising receiving the interference signal in real time wherein the interference signal is based on at least one of the propulsion mode and the load of a traction motor positioned proximate said signal coil assembly such that the interference component is facilitated being reduced.

17. A cab signal system comprising:
at least one inductive pickup coil assembly;
a cab signal receiver electrically coupled to said at least one inductive pickup coil assembly, said receiver configured to receive amplitude and phase information associated with an electromagnetic noise signal portion, and receive amplitude and phase information associated with a cab signal portion received by said at least one inductive pickup coil assembly; and
a phase shifter configured to determine a phase difference between electromagnetic noise signal portion and the cab signal portion and combine the electromagnetic noise signal portion and the cab signal portion based on the phase difference such that an amplitude of the electromagnetic noise signal portion is facilitated being reduced.

18. A system in accordance with claim 17 wherein said receiver is further configured to receive amplitude and phase information from a noise sensing coil configured to receive an electromagnetic noise signal from an AC traction motor.

19. A system in accordance with claim 17 wherein said receiver is further configured to receive at least one of a motor load signal and a propulsion mode signal.

20. A system in accordance with claim 17 wherein said receiver is further configured to shift the phase of the received electromagnetic noise signal portion in real time based on at least one of the propulsion mode and the load of a traction motor positioned proximate said at least one inductive pickup coil assembly such that a noise component of the cab signal portion is facilitated being reduced.
